(19) United States
(12) Patent Application Publication
(10) Pub. No.: US 2009/0043422 A1
(43) Pub. Date: Feb. 12, 2009

(54) PHOTOGRAPHING APPARATUS AND METHOD IN A ROBOT

(76) Inventors: Ji-Hyo Lee, Yongin-si (KR); Hyun-Soo Kim, Yongin-si (KR)

Correspondence Address: CHA & REITER, LLC, 210 ROUTE 4 EAST STE 103, PARAMUS, NJ, 07652, US

(21) Appl. No.: 12/186,611

(22) Filed: Aug. 6, 2008

(30) Foreign Application Priority Data
Aug. 7, 2007 (KR) 2007-0079240

(51) Int. Cl. G06F 19/00

(52) U.S. Cl. 700/245; 382/153; 700/259; 901/1

(57) ABSTRACT

A method and apparatus for taking a picture are provided, in which a mobile apparatus detects a current position of a mobile apparatus, moves from the current position to a predetermined position to take a picture, information about an ambient image around the mobile apparatus through the image sensor, after the movement, analyzes characteristics of the received image information, compares the analyzed characteristics with a predetermined picture-taking condition, controls the mobile apparatus for the characteristics of the image information to satisfy the predetermined picture-taking condition, if the characteristics of the image information do not satisfy the predetermined picture-taking condition, and takes a picture, if the characteristics of the image information satisfy the predetermined picture-taking condition.

### CLAIM OF PRIORITY

This application claims the benefit of the earlier filing date, under 35 U.S.C. §119(a), Korean Patent Application filed in the Korean Intellectual Property Office on Aug. 7, 2007 and assigned Serial No. 2007-79240, the entire disclosure of which is hereby incorporated by reference.

### BACKGROUND OF THE INVENTION

1. Field of the Invention

The present invention relates to photography. More particularly, the present invention relates to an apparatus and method for taking a photograph by a robot.

2. Description of the Related Art

Owing to the development of science and technology, robots have been finding their uses in a wider range of applications including industrial, medical, undersea, and home ones. For example, when an industrial robot is set to do what a human hand is supposed to do, it can repeatedly do the job. Also, a cleaning robot can clean in a manner similar to that of a person, e.g., vacuuming, floor washing, etc.

In the area of photography photographer robots equipped with a camera module may capture an object according to a user's command, convert the captured image to data, and store the image data.

However, a user may decide when the photographer robot should take a photograph and adjust the composition of a photograph each time a photograph is taken. This is inconvenient as the user may he required to be present or within a field of view of the robot.

Hence, there is a need in the industry for an apparatus and method for automatically determining when to take a picture, without user intervention.

### SUMMARY OF THE INVENTION

An aspect of exemplary embodiments of the present invention is to address at least the problems and/or disadvantages and to provide at least the advantages described below.

Accordingly, an aspect of exemplary embodiments of the present invention is to provide an apparatus and method for automatically determining when to take a picture.

Another aspect of exemplary embodiments of the present invention provides an apparatus and method for automatically adjusting picture composition.

In accordance with an aspect of exemplary embodiments of the present invention, there is provided a method for taking a picture in a mobile apparatus that has an image sensor for receiving image data and automatically takes a picture according to user setting, in which a current position of the mobile apparatus is detected, the mobile apparatus is moved from the current position to a predetermined position to take a picture, information about an ambient image around the mobile apparatus is received through the image sensor, after the movement, characteristics of the received image information are analyzed and compared with a predetermined picture-taking condition, the mobile apparatus is controlled so that the characteristics of the image information to satisfy the predetermined picture-taking condition, if the characteristics of the image information do not satisfy the predetermined picture-taking condition, and a picture is taken, if the characteristics of the image information satisfy the predetermined picture-taking condition.

In accordance with another aspect of exemplary embodiments of the present invention, there is provided a mobile apparatus for automatically taking a picture according to user setting, in which a camera module has an image sensor for receiving image data, a driver drives a motor for rotating or moving the mobile apparatus, a characteristic extractor detects at least one of a size, a position, and a number of face image data from image data, a position estimator and movement decider detects a current position of the mobile apparatus and calculates a movement direction and a movement distance from the current position to a picture-taking position, and a controller detects the current position, moves from the current position to the picture-taking position, receives information about an ambient image around the mobile apparatus through the image sensor, analyzes characteristics of the received image information, compares the analyzed characteristics with a predetermined picture-taking condition, controls the mobile apparatus for the characteristics of the image information to satisfy the predetermined picture-taking condition, if the characteristics of the image information do not satisfy the predetermined picture-taking condition, and takes a picture, if the characteristics of the image information satisfy the predetermined picture-taking condition.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 illustrates the movement path of a photographer robot according to an exemplary embodiment of the present invention;

FIG. 2 is a block diagram of the photographer robot according to an exemplary embodiment of the present invention;

FIG. 3 is a flowchart illustrating an operation for taking pictures in the photographer robot according to an exemplary embodiment of the present invention;

FIG. 4 is a flowchart illustrating an operation for taking a group picture in the photographer robot according to an exemplary embodiment of the present invention;

FIG. 5 is a flowchart illustrating an operation for taking a close-up picture in the photographer robot according to an exemplary embodiment of the present invention;

FIG. 6 is a flowchart illustrating an operation for taking a very close-up picture in the photographer robot according to an exemplary embodiment of the present invention; and

FIG. 7 illustrates exemplary pictures taken by the photographer robot according to an exemplary embodiment of the present invention.

Throughout the drawings, the same drawing reference numerals will be understood to refer to the same elements, features and structures.

### DETAILED DESCRIPTION OF THE INVENTION

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, in some cases, descriptions of well-known functions and constructions are omitted for clarity and conciseness so as not to obscure the novel elements described herein.

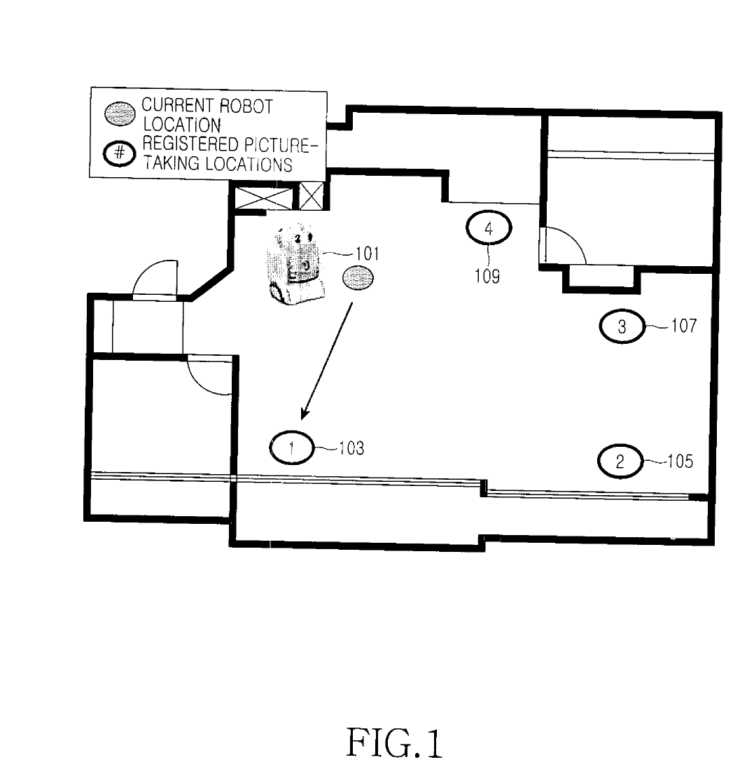

FIG. 1 illustrates the movement path of a photographer robot according to an exemplary embodiment of the present invention.

For notational simplicity, it is assumed herein that a photographer robot 101 is equipped with a camera module in the head and the head rotates up, down, left and night continuously with stops at predetermined angles. For instance, the photographer robot 101 may rotate upward at an angle of up to 30 degrees, downward at an angle of up to 15 degrees, left at an angle of up to 60 degrees, and right at an angle of up to 60 degrees or any angle between. In another aspect the robot 101 may rotate upward at an angle of up to 90 degrees, downward at an angle of up to 90 degrees, left at an angle of up to 90 degrees, and right at an angle of up to 90 degrees or any angle between.

Referring to FIG. 1, a user registers one or more picture-taking locations for the photographer robot 101 and the photographer robot 101 takes pictures, moving to the registered picture-taking locations. For example, the user beforehand registers first to fourth picture-taking locations 103, 105, 107 and 109, respectively. Upon request from the user, the photographer robot 101 takes pictures, moving from the first picture-taking location 103 to the second, third and fourth picture-taking locations 105, 107 and 109.

When the photographer robot 101 takes pictures of people at a picture-taking location, the pictures may include at least one of at least one group picture, at least one close-up picture, and/or at least one of a very close-up picture or one or more people within the group. In addition, the photographer robot 101 may take a predetermined sequence of pictures at a location. Fore example, robot 101 may sequentially take a group picture first, and then close-up and very close-up pictures, respectively.

A group picture refers to a picture of as many persons as possible. When taking a group picture, the photographer robot 101 analyzes image data received from the camera module and determines whether human faces are detected. If the human faces are detected, the photographer robot 101 automatically controls a picture composition by controlling the magnification of the camera module and rotating its head up, down, left and right according to information about the detected human faces (positions, sizes, number, etc.) and then takes a group picture. If no human face is detected, the photographer robot 101 rotates its head up, down, left and right until a human face is detected from image data received from the camera module. If the camera module is provided in the body of the photographer robot 101 the photographer robot 101 can rotate the body left and right at predetermined angles until a human face is detected in image data received from the camera module.

The photographer robot 101 determines whether a group picture-taking termination condition has been satisfied. If the group picture-taking termination condition has been satisfied, the photographer robot 101 prepares for taking a close-up picture. The group picture-taking termination condition can be set based on the number of group pictures taken so far. For example, if the number of group pictures taken so far is equal to or larger than a reference group picture number, the photographer robot 101 can prepare for taking a close-up picture. If the group picture-taking termination condition has not been satisfied, the photographer robot 101 takes another group picture.

A close-up picture refers to a picture of M to (M+m) persons. M is a minimum number of persons to be taken in a close-up picture and M+m is a maximum number of persons to be taken in a close-up picture. When taking a close-up picture, the photographer robot 101 increases the optical magnification of the camera module according to a known image magnification ratio and detects a human face by analyzing an image projected onto the camera module. Then the photographer robot 101 determines whether M to (M+m) human faces have been detected. If M to (M+m) human faces have been detected, the photographer robot 101 automatically controls the picture composition by adjusting the magnification of the camera module and rotating its head up, down, left and right according to information about the detected human faces (positions, sizes, number, etc.) and then takes a close-up picture. After taking the picture, the photographer robot 101 may rotate its head up, down, left and right at predetermined angles. The photographer robot 101 detects human faces by analyzing an image projected onto the camera module. On the other hand, if the number of detected human faces does not fall into the range from M to (M+m), the photographer robot 101 rotates its head up, down, left and right and detects human faces from an image projected onto the camera module.

The photographer robot 101 determines whether a close-up picture-taking termination condition has been satisfied. If the close-up picture-taking termination condition has been satisfied, the photographer robot 101 prepares for taking a very close-up picture. The close-up picture-taking termination condition can be set based on the number of close-up pictures taken so far. For example, if the number of close-up pictures taken so far is equal to or larger than a reference number of close-up pictures, the photographer robot 101 can prepare for taking a very close-up picture, considering that the close-up picture-taking termination condition has been satisfied. If the close-up picture-taking termination condition has not been satisfied, the photographer robot 101 may take another close-tip picture.

A very close-up picture refers to a picture of N to (N+n) persons, where the number N is less than the number M. N is a minimum number of persons to be taken in a very close-up picture and N+n is a maximum number of persons to be taken in a very close-up picture. When taking a very close-up picture, the photographer robot 101 rotates at a through an angle or moves toward persons and detects human faces by analyzing an image projected onto the camera module. Then the photographer robot 101 determines whether N to (N+n) human faces have been detected. If N to (N+n) human faces have been detected, the photographer robot 101 automatically controls the picture composition by adjusting the magnification of the camera module and rotating its head up, down, left and right according to information about the detected human faces (positions, sizes, number, etc.) and then takes a very close-up picture. After taking the very close-up picture, the photographer robot 101 may rotate its head up, down, left and right. The photographer robot 101 detects human faces by analyzing an image projected onto the camera module. On the other hand, if the number of detected human faces does not fall into the range from N to (N+n), the photographer robot 101 rotates its head up, down, left and right to detect additional human faces from an image projected onto the camera module.

The photographer robot 101 determines whether a very close-up picture-taking termination condition has been satisfied. If the very close-up picture-taking termination condition has been satisfied, the photographer robot 101 may move to a next picture-taking location. The very close-up picture-taking termination condition may be set based on the number of very close-up pictures taken so far. For example, if the number of very close-up pictures taken so far is equal to or larger than a reference number of very close-up pictures, the photographer robot 101 may terminate taking the very close-up pictures, considering that the very close-up picture-taking termination condition has been satisfied. If the very close-up picture-taking termination condition has not been satisfied, the photographer robot 101 may take another very close-up picture.

The picture-taking operation of the photographer robot 101 in the case where the user registers picture-taking locations in advance has been described with reference to FIG. 1. If the user does not register picture-taking locations, the photographer robot 101 may take pictures, moving along obstacle-free edges (i.e. walls), for example.

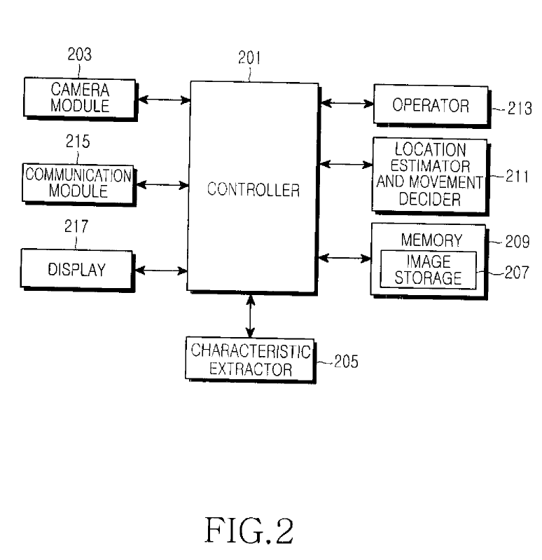

FIG. 2 is a block diagram of the photographer robot according to an exemplary embodiment of the present invention.

Referring to FIG. 2, the photographer robot 101 includes at least a controller 201, a camera module 203, a characteristic extractor 205, a memory 209, a location estimator and movement decider 211, a movement operator 213, a communication module 215, and a display 217.

The camera module 203 is provided with an I mage sensor and has zoom-in and zoom-out functions. The camera module 203 converts an image projected onto the image sensor to digital image data and provides the digital image data to the controller 201.

The memory 209 stores data for activating the photographer robot 101. In one aspect of the invention, the memory 209 stores captured (or taken) picture data in an image storage 207 according to the present invention. The picture data is a kind of image data that the controller 201 requests to be stored. An image database refers to a set of image data pre-stored by the user, and a map database refers to a set of map data corresponding to a building where the photographer robot 101 is located.

The location estimator and movement decider 211 determines the current location of the photographer robot 101 or determines whether to move the photographer robot 101. When the user registers picture-taking locations, the location estimator and movement decider 211 determines the current location of the photographer robot 101 referring to the current building map data, calculates a direction that the photographer robot 101 should take and a distance for which the photographer robot 101 should move from the current location, and notifies the controller 201 of the direction and distance according to the present invention.

The movement operator 213 rotates the photographer robot 101 left and right or moves it forward and backward by rotating a wheel in the body or moving legs if the robot is equipped with such locomotion features. The movement operator 213 may also direct the rotation of the head of the photographer robot 101 up, down, left and right.

The characteristic extractor 205 receives image data from the controller 201, detects face image data from the received image data by a face detection algorithm, and determines the sizes, locations, and number of the detected face image data. Notably, the characteristic extractor 205 may use a single or a plurality of face detection algorithms in detecting the face image data. The characteristic extractor 205 may also determine whether the detected face image data exists in the stored image database by comparing the detected face image data with the image database in a face recognition algorithm. In the presence of the detected face image data in the image database, the characteristic extractor 205 identifies persons corresponding to the detected face image data.

The communication module 215 communicates with an external server or another robot. The photographer robot 101 can receive information about a picture-taking spot, building map data, the position of the robot, etc from the user via the communication module 215.

The display 217 displays image information input from the image sensor and the predetermined image-taking condition.

The controller 201 controls the components of the photographer robot 101 to provide functions including photography. Especially when picture-taking locations are received from the user, the controller 201 registers them on the current building map data searched from the map database according to the present invention. Upon receipt of a picture-taking request from the user, the controller 201 controls the location estimator and movement decider 211 to move the photographer robot 101 to a picture-taking location. After a group picture-taking function has been invoked, the controller 201 receives image data from the camera module 203, provides the image data to the characteristic extractor 205, and controls the characteristic extractor 205 to detect face image data from the receive image data.

The characteristic extractor 205 also determines whether the sizes, positions, and number of the detected face image data satisfy a predetermined group picture-taking condition. The group picture-taking condition is set to check whether the image data received from the camera module 203 is a group image. Hence, the group picture-taking condition can specify predetermined sizes, positions, distribution, and number of face image data. If the received image data satisfies the group picture-taking condition, the controller 201 stores the image data in the memory 209, thus creating group picture data. On the other hand, if the received image data does not satisfy the group picture-taking condition, the controller 201 controls the movement operator 213 to rotate the header of the photographer robot 101 up, down, left and right to thereby automatically compose the image composition of a group picture. If the camera module 203 resides in the body of the photographer robot 101, the photographer robot 101 can rotate its body left and right until a human face is detected in image data received from the camera module 203.

After creating the group picture data, the controller 201 determines whether a group picture-taking termination condition has been satisfied. The group picture-taking termination condition is set for terminating the group picture-taking function. It can be the number of group pictures taken by the group picture-taking function. If the group picture-taking termination condition has been satisfied, the controller 201 may start a close-up picture-taking function. If the group picture-taking termination condition has not been satisfied, the controller 201 continues the group picture-taking function.

When the close-up picture-taking function starts, the controller 201 controls the camera module 203 to zoom in and receives new image data from the camera module 203. The controller 201 provides the image data to the characteristic extractor 205, controls the characteristic extractor 205 to detect the number, positions, and sizes of face image data, and determines whether the detected number, positions, and sizes satisfy a close-up picture-taking condition. The close-up picture-taking condition is set to check whether the image data received from the camera module 203 is a close-up image. Hence, the close-up picture-taking condition can specify predetermined sizes, positions, distribution, and number of face image data.

If the received image data satisfies the close-up picture-taking condition, the controller 201 stores the image data in the memory 209, thus creating close-up picture data. On the other hand, if the received image data does not satisfy the close-up picture-taking condition, the controller 201 controls the movement operator 213 to rotate the head of the photographer robot 101 up, down, left and right to adjust the image composition of a close-up picture. If the camera module 203 resides in the body of the photographer robot 101, the photographer robot 101 can rotate its body left and right until a human face is detected in image data received from the camera module 203.

After creating the close-up picture data, the controller 201 determines whether a close-up picture-taking termination condition has been satisfied. The close-up picture-taking termination condition is set for terminating the close-up picture-taking function. It can be the number of close-up pictures taken by the close-up picture-taking function. If the close-up picture-taking termination condition has been satisfied, the controller 201 starts a very close-up picture-taking function. If the close-up picture-taking termination condition has not been satisfied, the controller 201 continues the close-up picture-taking function.

When the very close-up picture-taking function begins, the controller 201 controls the movement operator 213 to move the photographer robot 101 toward objects, for example, and receives new image data from the camera module 203. The controller 201 provides the image data to the characteristic extractor 205, controls the characteristic extractor 205 to detect the number, positions, and sizes of face image data, and determines whether the detected number, positions, and sizes satisfy a very close-up picture-taking condition. The very close-up picture-taking condition is set to check whether the image data received from the camera module 203 is a very close-up image. Hence, the very close-up picture-taking condition can specify predetermined sizes, positions, distribution, and number of face image data.

If the received image data satisfies the very close-up picture-taking condition, the controller 201 stores the image data in the memory 209, thus creating very close-up picture data. On the other hand, if the received image data does not satisfy the very close-up picture-taking condition, the controller 201 controls the movement operator 213 to rotate the head of the photographer robot 101 up, down, left and right to automatically compose the image of a very close-up picture. If the camera module 203 resides in the body of the photographer robot 101, the photographer robot 101 can rotate its body left and right until a human face is detected in image data received from the camera module 203.

After creating the very close-up picture data, the controller 201 determines whether a very close-up picture-taking termination condition has been satisfied. The very close-up picture-taking termination condition is set for terminating the very close-up picture-taking function. It can be the number of very close-up pictures taken by the very close-up picture-taking function. If the very close-up picture-taking termination condition has been satisfied, the controller 201 ends the very close-up picture-taking function. If the very close-up picture-taking termination condition has not been satisfied, the controller 201 continues the very close-up picture-taking function.

When the very close-up picture-taking function is completed, the controller 201 determines whether the current status of the photographer robot 101 satisfies a picture-taking location changing condition. The picture-taking location changing condition is set to move the photographer robot 101 to the next picture-taking location. The picture-taking location changing condition can specify a reference picture-taking time and a reference picture data number for a picture-taking location. If the picture-taking location changing condition has been satisfied, the controller 201 controls the photographer robot 101 to move to the next picture-taking location. If the picture-taking location changing condition has not been satisfied, the controller 201 resumes the very close-up picture-taking function.

If the user has not registered picture-taking locations, the controller 201 searches the memory 209 for a map of a building where the photographer robot 101 is located and automatically registers one or more picture-taking locations along edges shown on the searched building map. Then the controller 201 controls picture taking at the automatically registered picture-taking locations in the above-described procedure.

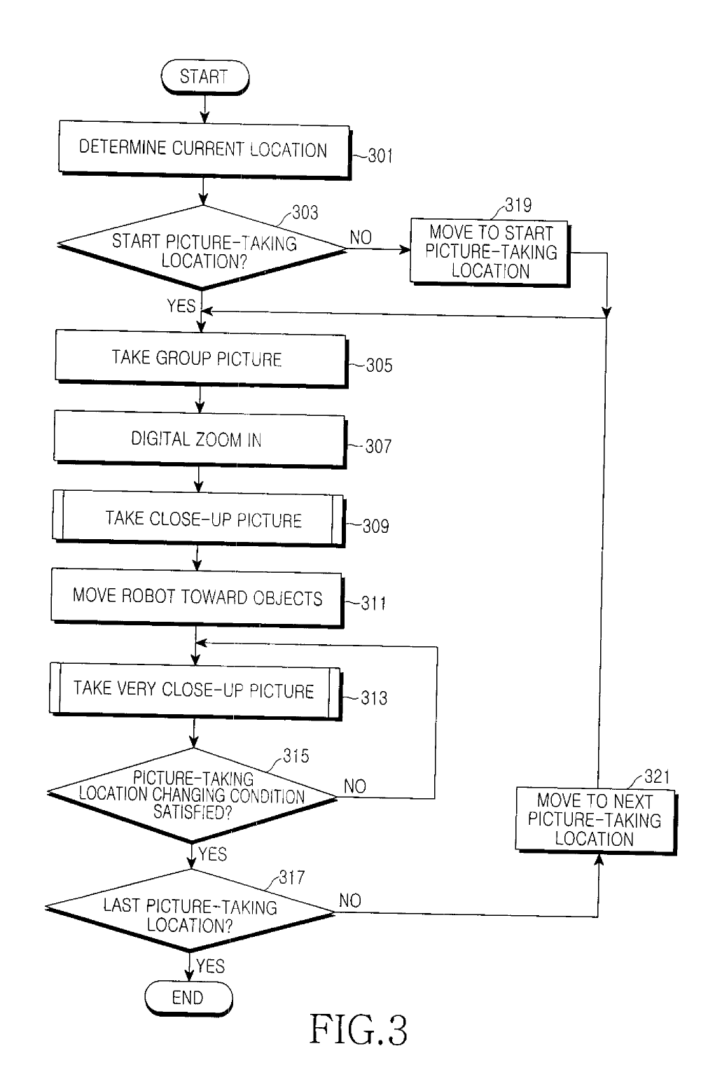

FIG. 3 is a flowchart illustrating an operation for taking pictures in the photographer robot according to an exemplary embodiment of the present invention.

For notational simplicity, it is assumed that the user registers picture-taking locations beforehand.

Referring to FIG. 3, the controller 201 searches for a map of a building where the photographer robot 101 is located in the map database stored in the memory 209 and determines the current location of the photographer robot 101 on the building map in step 301.

In step 303, the controller 201 determines whether the photographer robot 101 is supposed to start taking a picture at the current location. If the current location is a start picture-taking location, the controller 201 proceeds to step 305. If the current location is not the start picture-taking location, the controller 201 goes to proceeds 319.

In step 319, the controller 201 controls the location estimator and movement decider 211 to calculate a direction and a distance for the photographer robot 101 to move to a start picture-taking location, moves the photographer robot 101 for the distance in the direction, and then proceeds to step 305.

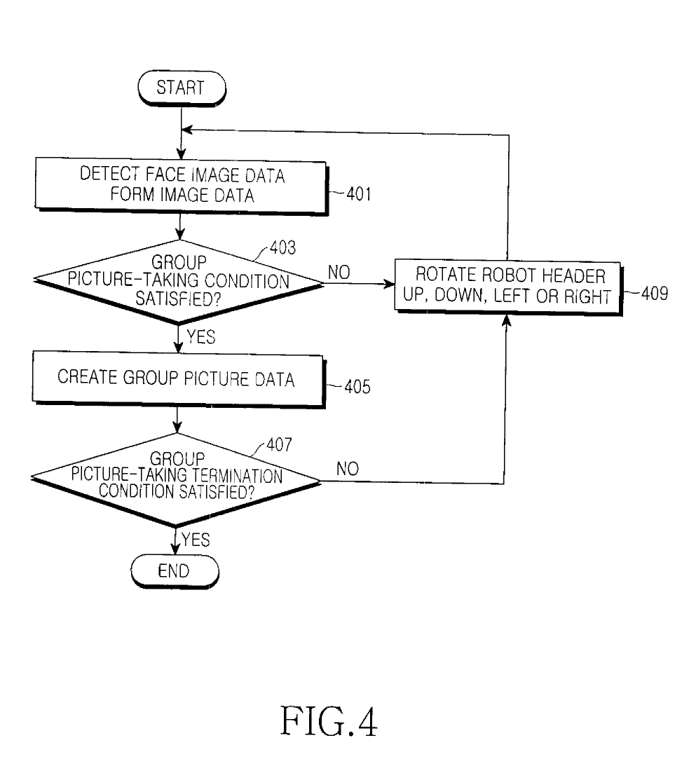

At step 305, the controller 201 generates group picture data by the group picture-taking function. Then the controller 201 proceeds to step 307. Step 305 will be described in more detail with reference to FIG. 4.

Referring to FIG. 4, the controller 101 controls the characteristic extractor 205 to detect face image data from image data received from the camera module 203 at step 401. The characteristic extractor 205 can determine the sizes, positions, and number of the detected face image data.

At step 403, the controller 201 determines whether the image data satisfies the group picture-taking condition. If the image data satisfies the group picture-taking condition, the controller 201 proceeds to step 405 and if the image data does not satisfy the group picture-taking condition, the controller 201 proceeds to step 409. The group picture-taking condition is set to check whether the image data received from the camera module 203 is group image data. Hence, the group picture-taking condition specifies predetermined sizes, positions, distribution, and number of face image data.

In step 409, the controller 201 controls the operator 213 to rotate the head of the photographer robot 101 up, down, left and right to thereby automatically the picture composition of a group picture, and then returns to step 401.

At step 405, the controller 201 creates group picture data using the received image data and stores the group picture data in the memory 209. Then the controller 201 proceeds to step 407.

At step 407, the controller 201 determines whether the group picture-taking termination condition has been satisfied. The group picture-taking termination condition is set for terminating the group picture-taking function. It can be the number of group picture data created by the group picture-taking function.

If the group picture-taking termination condition has been satisfied, the controller 201 terminates the group picture-taking function. If the group picture-taking termination condition has not been satisfied, the controller 201 changes the current group picture composition and receives image data according to the changed group picture composition at step 409.

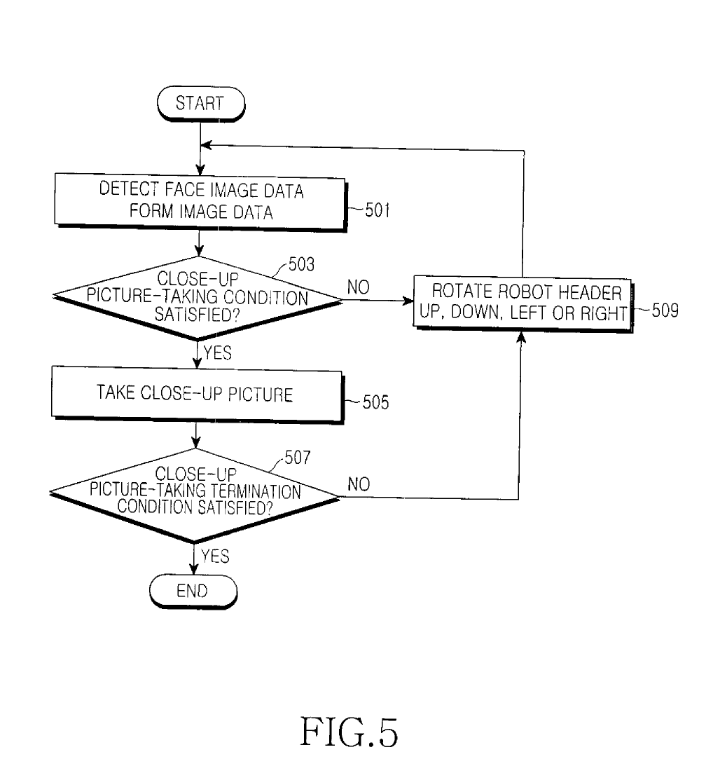

Returning to FIG. 3, after completion of the group picture function, the controller 201 controls the camera module 203 to zoom in at step 307 and to create close-up picture data by the close-up picture-taking function in step 309. Then the controller 201 proceeds to step 311. Step 309 will be detailed with reference to FIG. 5.

Referring to FIG. 5, the controller 201 controls the characteristic extractor 205 to detect face image data from image data received from the camera module 203 in step 501. Herein, the characteristic extractor 205 detects the number, positions, and sizes of the detected face image data.

At step 503, the controller 201 determines whether the received image data satisfies the close-up picture-taking condition. The close-up picture-taking condition is set to check whether the image data received from the camera module 203 is a close-up image data. Hence, the close-up picture-taking condition can specify predetermined sizes, positions, distribution, and number of face image data.

If the received image data does not satisfy the close-up picture-taking condition, the controller 201 controls the operator 213 to rotate the header of the photographer robot 101 up, down, left and right to automatically compose the image of a close-up picture at step 509 and then returns to step 501.

If the received image data satisfies the close-up picture-taking condition, the controller 201 creates close-up picture data using the received image data and stores the close-up picture data in the memory 209 at step 505 and proceeds to step 507.

At step 507, the controller 201 determines whether the close-up picture-taking termination condition has been satisfied. The close-up picture-taking termination condition is set for terminating the close-up picture-taking function. The termination condition may be the number of close-up picture data created by the close-up picture-taking function.

If the close-up picture-taking termination condition has been satisfied, the controller 201 terminates the close-up picture-taking function. If the close-up picture-taking termination condition has not been satisfied, the controller 201 changes the current close-up picture composition and receives image data according to the changed close-up picture composition in step 509.

Returning to FIG. 3, the controller 201 controls the operator 213 to move the photographer robot 101 to move toward objects, for example, in step 311.

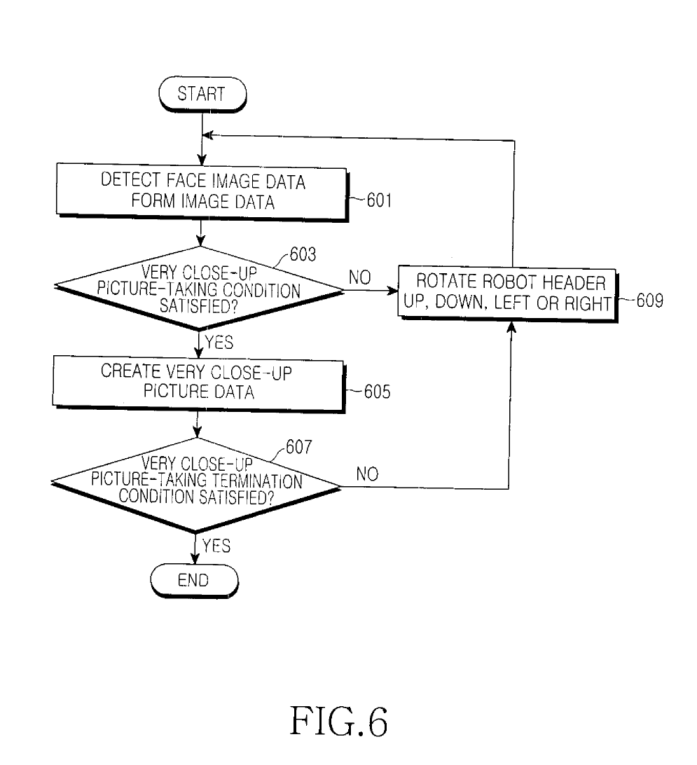

At step 313, the controller 201 receives very close-up picture data captured by the very close-up picture-taking function. Then the controller 201 proceeds to step 315. Step 313 will be described in more detail with reference to FIG. 6.

Referring to FIG. 6, the controller 201 controls the characteristic extractor 205 to detect face image data from image data received from the camera module 203 at step 601. The characteristic extractor 205 can detect a number, positions, and sizes of the face image data. At step 603, the controller 201 determines whether the received image data satisfies the very close-up picture-taking condition. The very close-up picture-taking condition is set to check whether the image data received from the camera module 203 is a very close-up image. Hence, the very close-up picture-taking condition determines whether at least one of a specify predetermined size and/or number of face image data has been satisfied.

If the received image data does not satisfy the very close-up picture-taking condition, the controller 201 controls the operator 213 to rotate the head of the photographer robot 101 up, down, left and right to compose the image of a very close-up picture at step 609 and returns to step 601.

If the received image data satisfies the very close-up picture-taking condition, the controller 201 creates very close-up picture data using the received image data and stores the very close-up picture data in the memory 209 in step 605 and proceeds to step 607.

At step 607, the controller 201 determines whether the very close-up picture-taking termination condition has been satisfied. The very close-up picture-taking termination condition is set for terminating the very close-up picture-taking function. The termination condition may, of example, be the number of very close-up picture data created by the very close-up picture-taking function.

If the very close-up picture-taking termination condition has been satisfied, the controller 201 ends the very close-up picture-taking function. If the very close-up picture-taking termination condition has not been satisfied, the controller 201 changes the current very close-up picture composition and receives image data according to the changed very close-up picture composition in step 609.

Returning to FIG. 3, the controller 201 determines whether the photographer robot 101 satisfies the picture-taking location changing condition in step 315. The picture-taking location changing condition is set to move the photographer robot 101 to the next picture-taking location. The picture-taking location changing condition can specify a reference picture-taking time and a reference picture data number for a picture-taking location.

If the picture-taking location changing condition has been satisfied, the controller 201 proceeds to step 317. If the picture-taking location changing condition has not been satisfied, the controller 201 proceeds to step 313.

In step 317, the controller 201 controls the location estimator and movement decider 211 to determine whether the current picture-taking location is a last picture-taking location. If the current picture-taking location is the last picture-taking location, the controller 201 ends all picture-taking functions. If the current picture-taking location is not the last picture-taking location, the controller 201 proceeds to step 321.

At step 321, the controller 201 searches for the next picture-taking location in the pre-registered picture-taking locations, controls the location estimator and movement decider 211 to calculate a direction and a distance for the photographer robot 101 to move to the next picture-taking location, and controls the operator 213 to move the photographer robot 101 for the distance in the direction. Then the controller 201 returns to step 305 to continue the picture-taking functions.

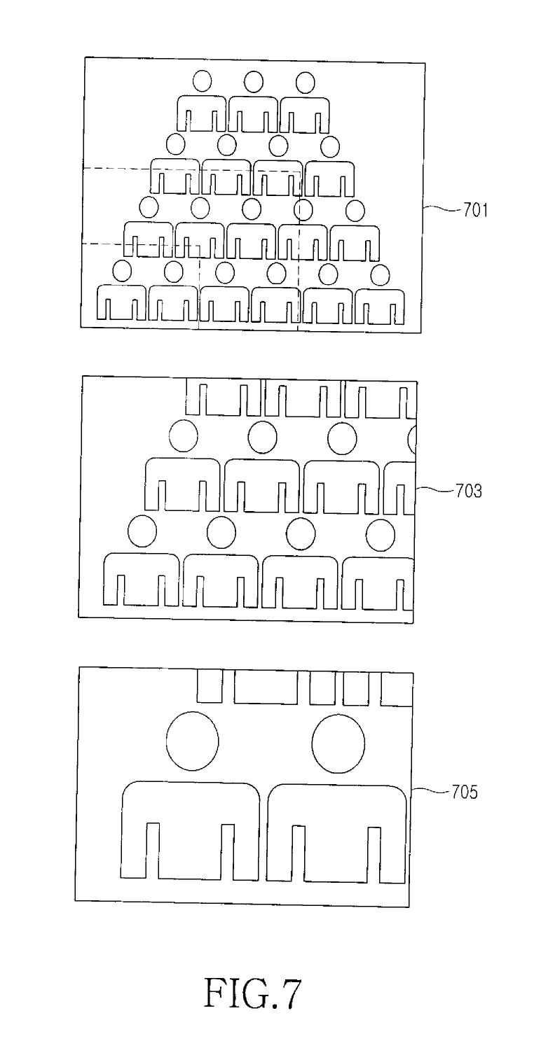

FIG. 7 illustrates exemplary pictures taken by the photographer robot according to an exemplary embodiment of the present invention.

Referring to FIG. 7, reference numeral 701 denotes a group picture taken by the group picture-taking function. The photographer robot 101 controls the picture composition so that the group picture 701 includes as many persons as possible and creates group picture data according to the controlled picture composition.

Reference numeral 703 denotes a close-up picture taken by the close-up picture-taking function. If the close-up picture-taking condition specifies seven or eight face image data, the photographer robot 101 controls the picture composition so that the close-up picture 703 includes seven persons and creates close-up picture data according to the controlled picture composition.

Reference numeral 705 denotes a very close-up picture taken by the very close-up picture-taking function. If the very close-up picture-taking condition specifies one, or two face image data, for example, the photographer robot 101 controls the picture composition so that the close-up picture 705 includes two persons and creates very close-up picture data according to the controlled picture composition.

As is apparent from the above description, the present invention advantageously decides when to take pictures automatically and controls picture composition automatically. Therefore, a user can take pictures by a photographer robot without the need for moving the photographer robot for each picture and commanding the photographer robot to take a picture.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain exemplary embodiments of the present invention thereof, they are merely exemplary applications. For example, while the group picture-taking condition, the close-up picture-taking condition, or the very close-up picture-taking condition specifies the number and sizes of face image data, it may further specify the illuminance and value of face image data. Also, while the picture-taking condition is set using face recognition in the exemplary embodiments of the present invention, it can be set using image data of an object extracted by object recognition. Also, the present invention can be used for not only the picture-taking but also video image-taking.

In addition, while it has been described that the camera module is provided in the head of the photographer robot 101, the camera module can be positioned in the body of the photographer robot 101. Thus, it will be understood by those skilled in the art that various changes in form and details may be made therein without departing from the spirit and scope of the present invention as defined by the appended claims and their equivalents.

What is claimed is:

1. A method for taking an image in a mobile apparatus that has an image sensor for receiving image data and takes an image according to user setting, the method comprising:
detecting a position of the mobile apparatus;
moving from the position to a predetermined position to take an image;
inputting an image information through the image sensor;
extracting characteristics of the inputted image information;
comparing the analyzed characteristics with a predetermined image-taking condition;
controlling the mobile apparatus for the characteristics of the image information to satisfy the predetermined image-taking condition, if the characteristics of the image information do not satisfy the predetermined image-taking condition; and
storing the image information, if the characteristics of the image information satisfy the predetermined picture-taking condition.

2. The method of claim 1, wherein the image information comprises still image or video image.

3. The method of claim 1, wherein the comparing the a analyzed characteristics with a predetermined image-taking condition comprises:
displaying inputted image information and predetermined image-taking condition.

4. The method of claim 1, wherein the position detection comprises locating the mobile apparatus using pre-stored building map data.

5. The method of claim 1, wherein the position detection comprises receiving information about the position or information about the predetermined position from a server.

6. The method of claim 1, wherein the characteristics of the image information include at least one of the number, sizes, and positions of face image data recognized from the image by face recognition.

7. The method of claim 1, wherein the characteristics of the image information include at least one of the number, sizes, and positions of object image data recognized from the image by object recognition.

8. The method of claim 1, wherein the picture-taking condition includes at least one of a number range, a size range, and a position range of face or object image data of the image.

9. The method of claim 1, wherein the controlling comprises controlling the image sensor to be zoomed-in or zoomed-out.

10. The method of claim 1, wherein the controlling comprises controlling the image sensor to rotate up, down, left or right.

11. The method of claim 1, wherein the controlling comprises controlling the mobile apparatus to move forward, backward, left or right.

12. A mobile apparatus for taking an image according to user setting, comprising:
a camera module having an image sensor for inputting image information;
a memory for storing the inputted image information through the image sensor;
a driver for driving a motor for rotating or moving the mobile apparatus;
a characteristics extractor for extracting characteristics of the inputted image information and comparing the analyzed characteristics with a predetermined image-taking condition; and
a controller for detecting a position of the mobile apparatus, moving from the position to a predetermined position, inputting an image information through the image sensor, controlling the mobile apparatus for the characteristics of the image information to satisfy the predetermined image-taking condition, if the characteristics of the image information do not satisfy the predetermined image-taking condition, storing the image information, if the characteristics of the image information satisfy the predetermined picture-taking condition.

13. The mobile apparatus of claim 12, further comprising a position estimator and movement decider for detecting a current position of the mobile apparatus and calculating a movement direction and a movement distance from the current position to a picture-taking position.

14. The mobile apparatus of claim 12, further comprising a display for displaying inputted image information and predetermined image-taking condition.

15. The mobile apparatus of claim 12, wherein the memory for pre-storing building map data, wherein the controller detects the position of the mobile apparatus using the pre-stored building map data.

16. The mobile apparatus of claim 12, further comprising a communication module for communicating a server and another apparatus, wherein the controller detects the position of the mobile apparatus by receiving information about the current position and information about the picture-taking position from the server.

17. The mobile apparatus of claim 12, wherein the characteristics of the image information include at least one of the number, sizes, and positions of face image data recognized from the image by face recognition.

18. The mobile apparatus of claim 12, further comprising an object detector and recognizer for detecting at least one of the number, sizes, and positions of object image data recognized from the image by object recognition, wherein the characteristics of the image information include at least one of the number, sizes, and positions of the object image data recognized from the image by object recognition.

19. The mobile apparatus of claim 12, wherein the picture-taking condition includes at least one of a number range, a size range, and a position range of face or object image data of the image.

20. The mobile apparatus of claim 12, the controller controls the image sensor to be zoomed-in or zoomed-out.

21. The mobile apparatus of claim 12, wherein the controller controls the image sensor to rotate up, down, left or right.

22. The mobile apparatus of claim 12, wherein the controller controls the mobile apparatus to move forward, backward, left or right.
